(19) United States
(12) Patent Application Publication
(10) Pub. No.: US 2010/0018355 A1
(43) Pub. Date: Jan. 28, 2010

(54) HEAD CAP FOR A WRENCH HEAD, WRENCH AND METHOD UTILIZING THE SAME

(76) Inventor: Ted C. Crawford, Denver, CO (US)

Correspondence Address: HOLLAND & HART, LLP, P.O BOX 8749, DENVER, CO, 80201, US

(21) Appl. No.: 12/299,597

(22) PCT Filed: May 4, 2007
(86) PCT No.: PCT/US07/10867

§ 371 Date: Sep. 25, 2009

Related U.S. Application Data
(60) Provisional application No. 60/746,460, filed on May 4, 2006.

(51) Int. Cl. B25B 23/00; B25B 13/46; B23P 11/00

(52) U.S. Cl. 81/60; 81/488; 29/428

(57) ABSTRACT

A head cap adapted to secure to the working head of a wrench. The head cap includes a generally flat plate portion having a peripheral edge and first and second wing portions that extend from said peripheral edge in generally parallel, opposed relation to one another and are oriented so as to engage the working head of the wrench. The flat plate portion has an exposed upper surface suitable for locating selected indicia.

### BACKGROUND

One of the more versatile tools used by mechanics and the like is the ratchet wrench. As is known, ratchet wrenches include a handle and a working head. Some ratchet wrenches directly engage a work piece, such as a nut or bolt head. Other ratchet wrenches have a drive stud projecting from a rotatable drive member, also sometimes referred to as a ratchet wheel. This drive stud is typically integral with the drive member. A ratchet mechanism selectively engages the drive member to permit rotation of the drive member in one direction while preventing rotation in a second, opposite rotational direction. The ratchet mechanism is actuable so as to selectively permit rotation of the drive member in either a clockwise or counterclockwise direction. Usually, a lever is provided on the working head to allow the user to select the desired rotation of the drive stud.

The drive stud, in turn, receives a selected one of a plurality of sockets, socket adapters, extenders, and the like, which may be referred to as a work piece that engages the nut or bolt head. A socket, for example, has an opening sized and adapted to receive the drive stud. A second opening is located oppositely of the drive stud opening with this second opening having teeth and an opening sized to receive a nut, bolt head and the like. A set of such sockets is usually provided allowing the user to interchange sockets for differently sized nuts and bolts. Adapters and extenders have an opening to receive the drive stud and an opposite drive stud to receive a socket or other piece.

As an example, professional mechanics, racing team mechanics, shade-tree mechanics and the like all rely on the ratchet wrench. In addition, individuals who work on cars, trucks, motorcycles, aircraft, and generally vehicles of all types, often hold a loyalty to a particular brand of tool, racing team, or make of vehicle. As such mechanics often display logos or other indicia of their favorite brands on their toolboxes. Combining the importance of the ratchet wrench and the mechanics brand loyalty presents an opportunity to brand the ratchet with a logo, emblem, symbol, name or other indicia.

One disadvantage of existing ratchet wrenches is that, typically, portions of the operative mechanism project through the upper surface of the working head. These protruding mechanical elements act to increase the effective thickness of the working head. In addition, they can sometimes interfere with the use of the wrench, especially in confined spaces. Moreover, the protruding elements clutter the working head upper surface and do not permit the upper surface to receive identifying indicia, logos, emblems or other desired designations.

The drive stud on the working or “ratchet head” also often employs a ball detent to retain the selected socket, adapter or extender on the drive stud. To remove the socket, the user typically grips the head of the wrench in one hand and the socket in the other in order to separate the socket from the wrench head. Sometimes, removal of the socket from the drive stud is difficult. This can arise should dirt affect the actuation of the ball detent. Other times, should the user's hands be oily or greasy, it is difficult to obtain sufficient grip on the cylindrical socket in order to effect separation. Indeed, small variations due to manufacturing tolerances can exacerbate the difficulty of removal of the socket, adapter, extender, etc.

In order to ease the procedure of removing a socket from the drive stud, it is known to provide ratchet wrenches with a “quick release” mechanism. An early example of a quick release mechanism is disclosed in U.S. Pat. No. 3,208,318 issued Sep. 28, 1965 to Roberts. Here, the detent ball interacts with a cavity on a release pin, which is axially disposed in the drive stud and is reciprocal in the longitudinal direction. The release pin has a head that protrudes from the wrench, opposite the drive stud, to provide a button whereby a user can depress the release pin against the force of a return spring. Depressing the release pin moves the cavity into registration with the detent ball so that there is no spring actuated force on the detent ball allowing the socket to be easily removed. When released, the release pin is biased so that it presses against the detent ball thereby retaining the socket on the drive stud. Another example of a quick release mechanism is disclosed in U.S. Pat. No. 4,420,995 issued Dec. 20, 1983 to Roberts. Here, the reciprocating release pin is rotatable to provide a positive locking structure for the detent ball.

While the above-described mechanisms are reliable and effective in use, the possibility exists that, under some conditions, a user may inadvertently depress the release pin while using the wrench. This can happen, for example, if the head of the wrench is placed in the palm of the users hand since the hand can come in contact with the button or head of the release pin and can inadvertently depress the same while the wrench is used thereby inadvertently releasing the socket.

In order to overcome these drawbacks, a slide actuator for the release pin is disclosed in U.S. Pat. No. 6,109,140 issued Aug. 29, 2000 to Roberts et al. In this structure, the head of the release pin is not exposed exteriorly of the working head. Rather, a slide actuator projects upwardly from the drive head directly above the release pin and reciprocates in a direction transverse to the rotational axis of the drive stud and thus the longitudinal axis of the release pin. The slide actuator has a ramp face, which attacks the head of the release pin so that reciprocation of the slide actuator acts to depress or release the release pin. U.S. Pat. No. 5,582,080 issued Dec. 10, 1996 to Barmore discloses a similar structure for actuating the release pin.

Again, the structure disclosed in the '140 patent is generally reliable and effective. However, the slide actuator requires that the user adjust his/her grip on the handle or use his/her other hand while gripping the wrench in order to employ the quick release. In addition, the wrench disclosed in the '140 patent has the ratchet reversing lever located on the head of the wrench which results in multiple mechanisms presenting a cluttered appearance for the head. In addition, since the slide actuator projects upwardly from the working head, it can interfere with using the wrench in confined spaces.

Accordingly, there is a need for improved ratchet wrenches having a more streamlined appearance including generally flat and generally uninterrupted upper surfaces. There is also a need for ratchet wrenches having quick release mechanisms wherein the working head has a reduced profile. There is a further need for a ratchet wrench having an uninterrupted surface to provide an area for selected designs, logos, emblems, or indicia. An uninterrupted surface would also be useful for providing an attachment point for accessories such as lights, mirrors, and belt clips. It is also desirable to have such an uninterrupted surface in the form of a replaceable ratchet wrench cover or alternatively, a permanent ratchet wrench cover that easily snaps into position.

### SUMMARY

It is an object of the present invention to provide a new and useful head cap for a wrench and a wrench incorporating such a head cap.

According to some exemplary embodiments of the present invention, the head cap provides indicia for the wrench, and in other embodiments, the head cap provides structure for mounting an accessory onto a wrench.

It is an aspect of the exemplary embodiments to provide a head cap that mounts on the working head of a wrench so as to provide an exposed upper surface therefore.

One aspect of these embodiments is a head cap that provides an exposed surface that is generally uninterrupted.

Another aspect of the exemplary embodiments is a head cap that snap fits onto the working head of a wrench, such as a ratchet wrench.

Still a further aspect of these embodiments is to provide structure so that a head cap may be mounted on the working head of a wrench, such as a ratchet wrench, in a releasable and interchangeable manner so that different head caps may be selected for a common wrench construction.

Another aspect of the exemplary embodiments is to provide a head cap for a ratchet wrench wherein the head cap also serves to secure some of the components of the drive mechanism and/or a ratchet control mechanism within the working head.

According to these exemplary embodiments, then, an improvement is disclosed in the form of a head cap for the working head of a wrench, such as a ratchet wrench, wherein the wrench includes a forwardly located working head having a lower tool piece and a surrounding side wall extending between an upper edge and a lower edge that is opposite the upper edge. The wrench includes a handle that extends longitudinally and rearwardly of the working head along the longitudinal axis. The head cap is securable to the working head in a mounted state with the head cap having an exposed surface that forms an upper surface for the working head when in the mounted state.

In the exemplary embodiments, the head cap includes a generally flat plate portion that spans a majority of the region surrounded by the upper edge of the working head of the wrench. To this end, the head cap may have a peripheral edge that is substantially co-extensive with the upper edge of the working head when in the mounted state. This exposed surface may then be provided with selected indicia thereon. In some embodiments, the exposed surface has a recess formed therein and includes an insert piece that is sized and adapted to nest in this recess. In other embodiments, the head cap includes a mounting element disposed on the upper surface with this mounting element being configured to releasably attach a selected accessory to the head cap and therefore to the wrench. In some embodiments, the peripheral edge portion includes a peripheral shoulder that defines a central portion that may engage a rim that surrounds the upper edge of the working head. This shoulder provides a way of locating the head cap on the working head in a manner that resists a lateral displacement.

In the exemplary embodiments, the head cap is constructed of a stiff, resilient material. In these embodiments, at least one wing or skirt portion is described. In several embodiments, first and second wing portions project downwardly from the peripheral edge of the flat plate portion in a downwardly depending manner so as to engage the surrounding sidewall of the working head when in the mounted state. Here, the working head of the wrench has wing recesses corresponding to the downwardly depending wing portions of the head cap so that the wing portions may mate in these wing recesses. As described, a pair of side wing portions may downwardly depend from the peripheral edge portion in opposed relation to one another. Additionally, if desired, a downwardly depending front wing portion may be located forwardly of each of the first and second wing portion (the side wing portions). The front wing portion is also operative to engage the surrounding side wall of the working head when in the mounted state. The side wing portions may be oriented at a small acute angle relative to a longitudinal plane that is perpendicular to the flat plate portion to assist and “snap-locking” the head cap to the working head.

In the exemplary embodiments, each wing portion and the sidewall of the working head are provided with cooperative interlock structures that are operative to engage one another so as to secure the head cap to the working head. One of the interlock structures may be a cavity and the other may be a protrusion sized to mate with the cavity. In the exemplary embodiments, the surrounding sidewall of the working head is provided with a cavity and the wing portion or portions are provided with a protrusion to engage such cavity or cavities. Where wing recesses are provided to mate with the wing portions, the cavities are formed within the wing recess. Here, also, the wing portion or portions may have a notch formed therein to assist in releasing the head cap from the mounted state. The protrusions and the corresponding cavities to receive the protrusions, may take a variety of shapes, including a ramp-like shape.

One aspect of the exemplary embodiments of the present invention is also directed to a method of providing a wrench with selected indicia wherein the wrench has a working head as described above. While this method may include any steps inherent in the exemplary embodiments, the method may broadly include providing a head cover that has a generally flat plate portion having a peripheral edge portion and opposite first and second surfaces and that has the selected indicia located on the first surface. The method then includes the step of securing the head cap to the working head in a mounted state such that the second surface confronts the working head with the first surface forming an exposed surface on the working head. Here, the flat plate portion is sized and configured so that it spans a majority of the region surrounded by the upper edge of the working head with the peripheral edge portion being substantially coextensive with that upper edge when in the mounted state.

These and other aspects of the present invention will become more readily appreciated and understood from a consideration of the following detailed description of the exemplary embodiments when taken together with the accompanying drawings, in which:

### BRIEF DESCRIPTION OF THE DRAWINGS

FIG. 1 is a side view in elevation of a ratchet wrench according to a first exemplary embodiment;

FIG. 2 is a top plan view of the ratchet wrench of FIG. 1;

FIG. 2A is a cross-sectional view taken about section line 2A-2A of FIG. 2;

FIG. 3 is an end view in elevation of the ratchet wrench of FIG. 1;

FIG. 4 is an exploded isometric view of a ratchet wrench according to the first exemplary embodiment;

FIG. 4A is an enlarged partial isometric view of the ratchet head as shown in FIG. 4;

FIG. 5 is a is an isometric view of the ratchet wrench cover as viewed from the bottom of the cover shown in FIGS. 14;

FIG. 6 is a is an isometric view of the ratchet wrench cover as viewed from the top of the cover of FIG. 5;

FIG. 7 is a side view in elevation of the ratchet wrench cover;

FIG. 8 is a top plan view of the ratchet wrench cover shown in FIG. 7;

FIG. 9 is a bottom plan view of the ratchet wrench cover shown in FIG. 7;

FIG. 10 is an end view in elevation of the ratchet wrench cover shown in FIG. 7;

FIG. 11 is a side view in elevation similar to FIG. 7 of another embodiment of the ratchet wrench cover;

FIG. 12 is a bottom plan view of the embodiment of the ratchet wrench cover shown in FIG. 11;

FIG. 13 is an end view in elevation of the embodiment of the ratchet wrench cover shown in FIG. 11;

FIG. 14 is an enlarged partial view of the embodiment of the ratchet wrench cover illustrating the detail of the snap feature shown in FIG. 13;

FIG. 15A is an isometric view of the ratchet wrench cover as viewed from the bottom of the cover showing an alternative embodiment of the snap feature;

FIG. 15B is an isometric view of the ratchet wrench cover as viewed from the bottom of the cover showing an alternative embodiment of the snap feature;

FIG. 15C is an isometric view of the ratchet wrench cover as viewed from the bottom of the cover showing an alternative embodiment of the snap feature;

FIG. 16 is a partially exploded isometric view of a ratchet wrench showing another embodiment of the ratchet wrench cover;

FIG. 17 is a side view in elevation of the ratchet wrench showing yet another embodiment of the ratchet wrench cover with a domed indicia surface;

FIG. 18 is an isometric view of another embodiment of the ratchet wrench cover that includes an accessory attachment feature;

FIG. 19 is an end view in elevation of the cover depicted in FIG. 18;

FIG. 20A is an end view in elevation of the cover shown in FIGS. 18 and 19 but with an alternative attachment feature;

FIG. 20B is an end view in elevation of the cover shown in FIGS. 18 and 19 but with an alternative attachment feature;

FIG. 20CA is an end view in elevation of the cover shown in FIGS. 18 and 19 but with an alternative attachment feature;

FIG. 21 is an isometric exploded view of an embodiment of the cover shown in FIG. 18 with an attached accessory in the form of a small flashlight;

FIG. 22 is an exploded view in perspective showing another embodiment of the present invention used with a box end wrench;

FIG. 23 is a bottom plan view of the head cap of FIG. 22;

FIG. 24 is a cross-sectional view taken about lines 24-24 of FIG. 23; and

FIG. 25 is a side view in elevation and partial cross-section of another embodiment of the present invention used with still a different type of wrench.

### DETAILED DESCRIPTION

The present invention broadly concerns a head cap for a wrench and a wrench incorporating such a head cap. The invention also concerns a method for providing a wrench with indicia such as logos, trademarks, designs, names, or emblems. The exemplary embodiments of the invention are describe with respect to a ratchet wrench, but it should be understood that the invention is not strictly limited to only ratchet-type wrenches.

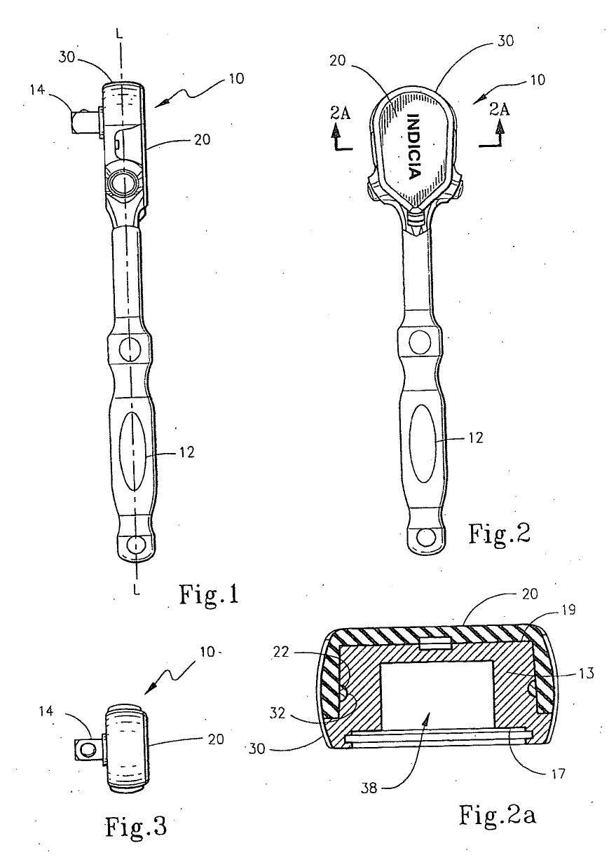

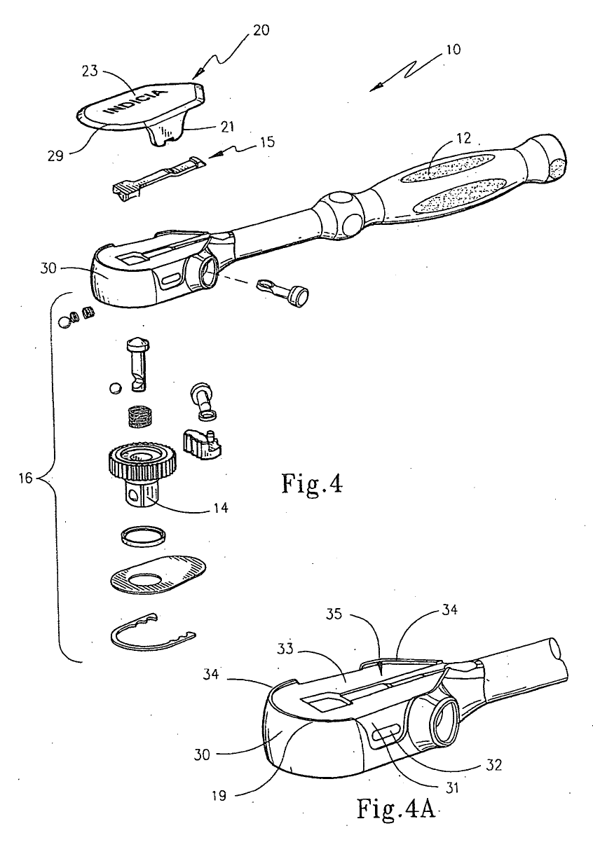

Therefore, with reference to FIGS. 1, 2 and 3, a ratchet wrench 10 is illustrated that is provided with an exemplary embodiment of the head cap of the present invention. Ratchet wrench 10 includes a handle 12 extending along a longitudinal axis L-L with a “working” or ratchet head 30 disposed at a distal end of the handle 12. Attached to the ratchet 30 is ratchet head cap or cover 20. FIG. 4 shows a detailed and exploded view of ratchet wrench 10.

Ratchet head 30 is configured to receive drive mechanism components 16 that are operative to rotate a drive stud 14 in selected direction. Drive stud 14 may thus be considered a lower tool piece in this embodiment. Head portion 30 also receives control components, for example to control the direction of rotational ratcheting. The drive mechanism 16 and slide actuator 15 are described in my previous application PCT/US2005/047525 filed Dec. 20, 2005, which is incorporated in its entirety herein by reference. Thus, ratchet head 30 includes a surrounding sidewall 13 having a lower edge 17 and an opposite upper edge 19 (FIG. 2A).

As can be seen in FIG. 4, ratchet head cover 20 is engineered to engage ratchet head 30 via wing portions 21. It should be noted that slide actuator 15 is retained in its operating position by ratchet head cover 20 includes a generally flat plate portion 23 with a surrounding peripheral edge portion 29 when ratchet head cover 20 is snapped into position. To this end, also, the interior, non-exposed surface 25 of ratchet head cover 20 may include a channel 55 configured to receive a portion of slide actuator 15 Ratchet head cover 20 also includes an exposed indicia surface 24 (FIG. 6) for printing, embossing, or attaching logos, trademarks, designs, names, or emblems. The indicia may be silk-screened, hot-stamped, pad-printed, laser printed, decaled, embossed, or molded onto or into the indicia surface 24. Indicia surface 24 may also include an attachment point for accessories. The ratchet head cover provided herein is also engineered to be removable or changeable. As described in detail below, the cover may be configured so that it is easily removed with a small screwdriver or such that removal requires a special tool or destruction of the cover.

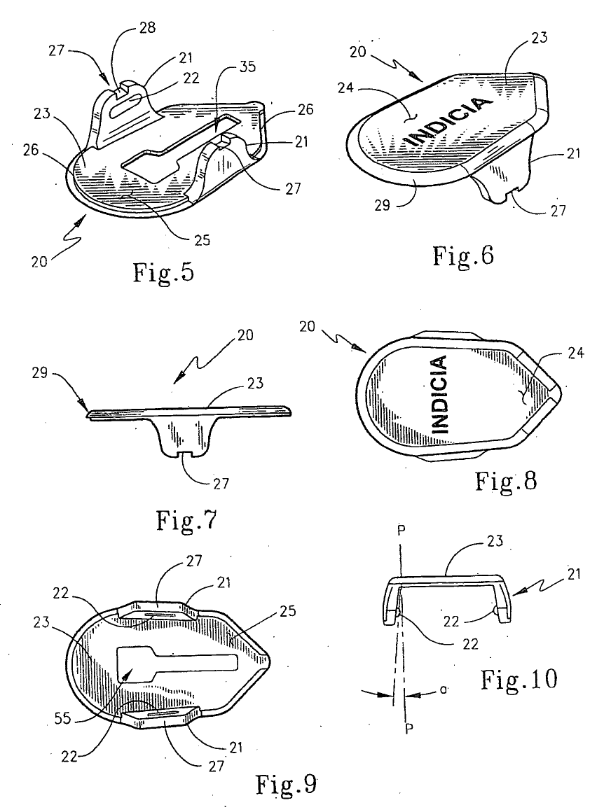

With reference to FIG. 4A it can be seen that wing recess 31 located on ratchet head 30 is sized and configured to receive wing 21 of the ratchet head cover 20. FIGS. 5-10 all illustrate the ratchet head cover 20 in greater detail. With reference to FIGS. 2A, 4A, and FIGS. 5-10 the installation of ratchet head cover 20 can be better appreciated. With reference again to FIG. 4A, a top wall 33 is partially surrounded by retaining rim 34 that is proximate to upper edge 19. Rim 34 and top wall 33 accordingly forms a shallow cover recess cavity 35. Bottom surface 25 of the ratchet head cover 20 confronts surface 33 of the ratchet head 30 when in the mounted state. The perimeter of the ratchet head cover 20 has a shoulder 26 (FIG. 5), which corresponds in size and configuration to the retaining rim 34 of ratchet head 30.

Upon assembly, shoulder 26 engages retaining rim 34 to ensure that the ratchet head cover 20 is centered on the ratchet head 30 and that lateral support is provided to the cover in the event that the ratchet is dropped or otherwise impacted. The outer perimeter of the head cover is provided with a radius “r” to prevent the head cover catching on surfaces when employing the ratchet wrench in tight spaces.

Ratchet head cover wing portions 21 engage in recesses 31 located on the sides of ratchet head 30. Each wing portion 21 includes cooperative interlocking features such as a snap feature or protrusion 22 that is sized and configured to engage snap cavity 32 located on the sides of the ratchet head 30 within the wing recess cavities 31. Once engaged, protrusions 22 act to retain the ratchet head cover 20 in position (See FIG. 2A).

With reference to FIG. 10 it should be noted that wing portions 21 are formed at a small acute angle “a” relative to a longitudinal plane “P” that is perpendicular to the plane of flat plate portion 23. This facilitates location of the ratchet head cover on the ratchet head, especially for automated assembly. Angle “a” also acts to wedge the ratchet head cover 20 onto the ratchet head 30. Angle “a” may range from zero to approximately twenty degrees. The head portion 30 should include a mating angle that is less than or equal to the head cover angle “a”. In the case where ratchet head cover 20 is of a molded construction, angle “a” will also facilitate release from the mold.

Ratchet head cover 20 may be formed of any material that is sufficiently flexible, when formed into the thin cross-section of wings 21, to allow the wings to deflect without yielding such that the cover may be installed. Such materials include, for example, steel, aluminum, titanium, carbon fiber, fiberglass, and plastic. Preferably, the cover is molded from polymeric material that when polymerized is strong and stiff. An example of such a material is polyamide 66 plastic resin such as Dupont® Zytel® 101. Fibers may also be added to the material to increase the strength.

In reference to FIGS. 9 and 10, it can be seen that snap features 22 are of a rounded configuration, thus allowing the subsequent removal of the ratchet head cover 20. To further facilitate the removal and replacement of the ratchet head cover 20 each wing portion 21 is provided with a removal notch 27. Removal notch 27 is provided with an angled surface 28 which provides a surface against which the wing portion 21 may be pried away from the ratchet head 30 with a small tool, thereby releasing snap feature 22 from snap cavity 32 to release the ratchet head cover 20 from the ratchet head 30.

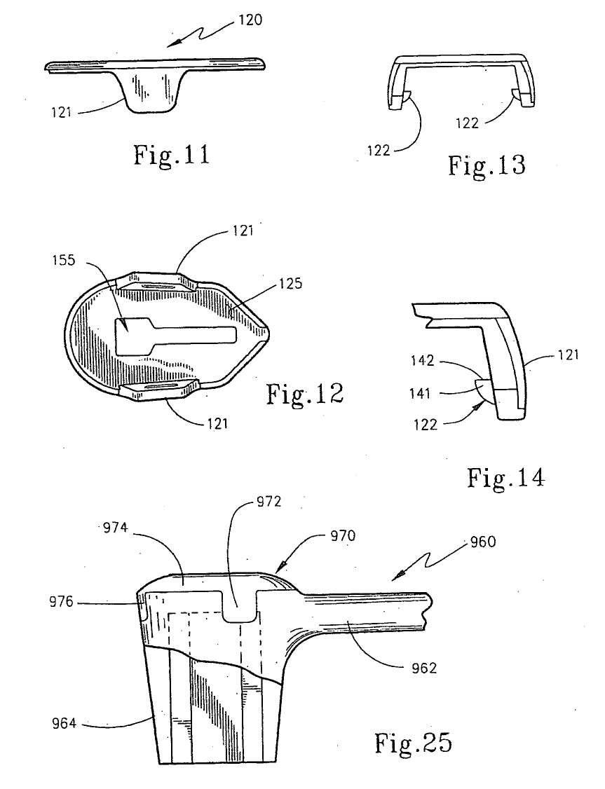

FIGS. 11, 12, and 13 illustrate an alternative embodiment of the ratchet head cover 120. In this embodiment, end portions 121 include a ramp-like protrusion or snap feature 122 that is configured to provide a permanent installation of a ratchet head cover 120. Referencing FIG. 14, snap feature 122 includes a ramp portion for facilitating the installation of the ratchet head cover 120. Snap feature 122 also includes lock surface 142 that mates with the ratchet head in a permanent fashion. Locking surface 142 may be flat or slightly angled to ensure that the snap feature is not easily removed from the snap cavity. In addition and with reference to FIG. 11, end portions 121 do not include a removal notch as in the previous embodiment. Again, a channel 155 may be provided to receive a portion of the slide actuator.

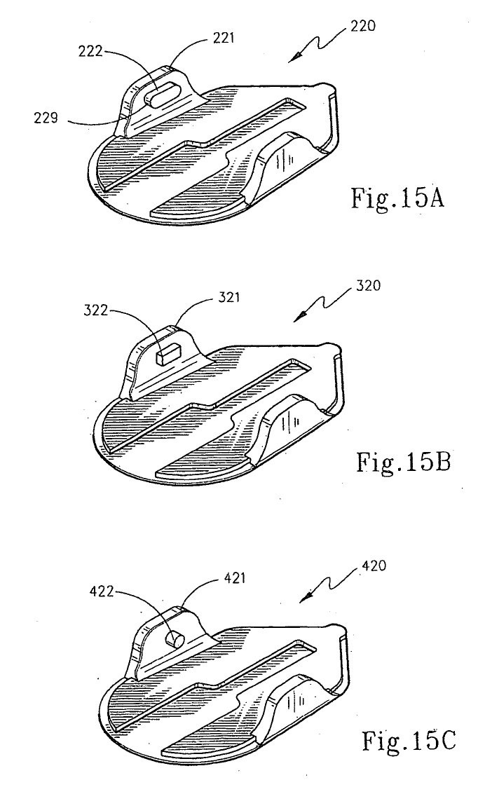

FIGS. 15A, 15B, and 15C show alternative embodiments of the snap feature. FIG. 15A illustrates a ratchet head cover 220 with a snap feature 222 that is oblong in shape having rounded end portions 229. FIG. 15B illustrates a ratchet head cover 320 with a snap feature 322 that is rectangular in shape. FIG. 15C illustrates a ratchet head cover 420 with a snap feature 422 that is cylindrical in shape. With reference to FIGS. 15A, 15B, and 15C it should be understood that the head portion of the ratchet wrench would be provided with a snap recess that corresponds in size and shape to the snap features shown in the corresponding figures. It should also be understood that the head covers shown in FIGS. 15A, 15B, and 15C could be configured to be difficult to remove from the head, as is shown in the figures, or may be configured with a removal notch as best shown in FIGS. 5 and 6.

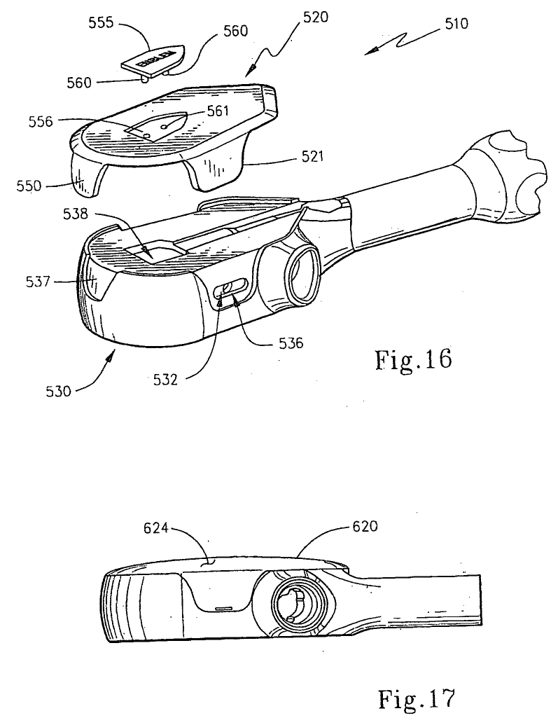

Illustrated in FIG. 16 is yet another embodiment of a ratchet wrench 510. Ratchet head cover 520 includes two wing portions 521 and also a front wing portion 550. Front wing portion 550 provides further support for the ratchet head cover 520. Head portion 530 includes removal access holes 536 that allow access from the interior 538 (also see 38 FIG. 2A) of head portion 530 to the bottom of snap recess 532. Removal access holes 536 allow the tool manufacturer to remove ratchet head cover 520 by inserting a tool through the access holes 536 to push the snap features out of snap recesses 532. Head cover 520 also includes a recess 556 sized and configured to receive an emblem 555. Emblem 555 is a form of indicia that may be that of a tool brand, vehicle make, racing team, or the name of the tools owner. Emblem 555 may be secured to the head cover 520 with glue or it may be fastened with studs 560. Head cover 520 also includes thru holes 561 sized to receive studs 560. Studs 560 may be threaded in which case a nut may be assembled after insertion through holes 561. Preferably, however, the studs 560 may be formed of a plastic that can be melted subsequent to insertion through holes 561 thereby retaining the emblem 555 in recess 556.

FIG. 17 illustrates a further embodiment of the ratchet head cover 620 where the indicia face 624 is of a domed shape. It is also contemplated that the indicia surface 624 could be formed in a variety of three-dimensional shapes including shapes that represent portions of an automobiles exterior design.

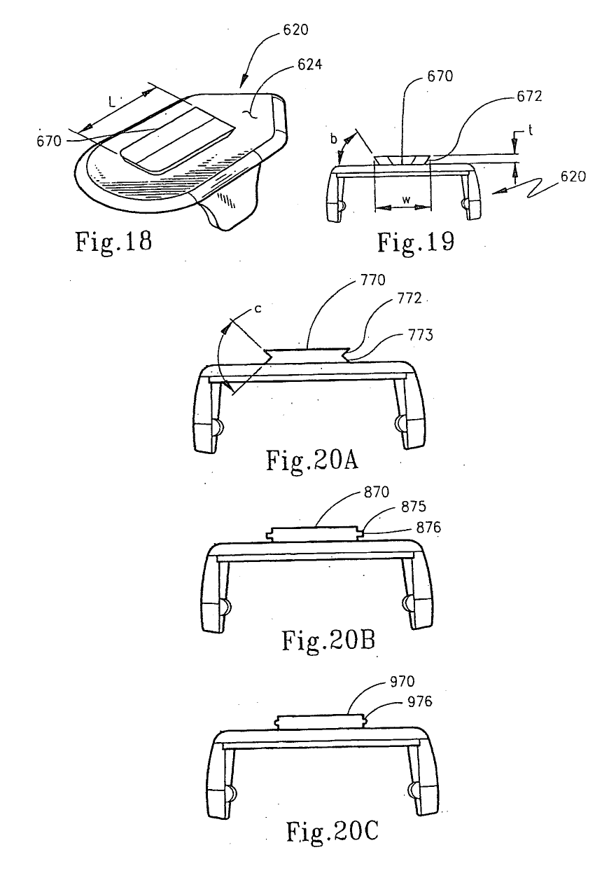

In yet another embodiment of the ratchet head cover shown in FIGS. 18 and 19, the cover 620 includes a mounting element 670 for attaching accessories to the wrench. Accessories that would be useful to attach to a ratchet wrench include, for example, a small flashlight, a laser, a mirror, a belt clip, or the like. FIG. 19 depicts the attachment feature having a dovetail configuration. The dovetail feature has a length “L,” a width “w,” and a thickness “t.” The sides 672 of the dovetail have an acute angle “b” relative to indicia surface 624.

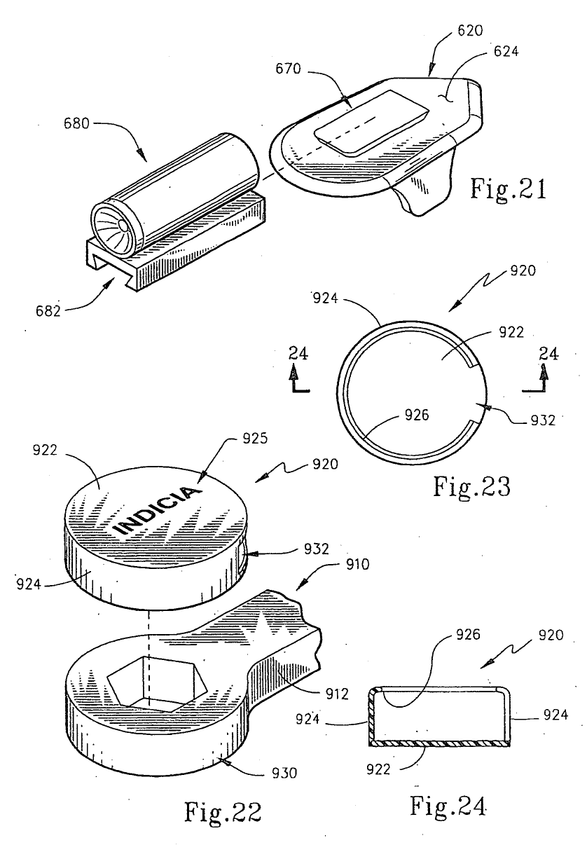

FIGS. 20A, B, and C show several possible configurations of the attachment feature The attachment feature 770 shown in FIG. 20A has a triangular groove where the sides of the groove 772 and 773 are formed at an angle “c” to each other. The attachment feature may be formed with a lengthwise rail 875 having a flat outer surface 876 as shown in FIG. 20B. Similarly, with reference to FIG. 20C, the lengthwise rail may be formed with a radiused outer edge 976 as is shown on attachment feature 970. FIG. 21 illustrates the attachment of a small flashlight 680 to the attachment feature 670 of cover 620. Flashlight 680 includes a dovetail groove 682 that is sized and configured to mate with the dovetail configuration of attachment feature 670. The flashlight 680 is attached to the cover 620 by sliding the flashlight onto the attachment feature as indicated in FIG. 21.

In reference now to FIGS. 22-24, an alternative embodiment of a head cap or cover 920 is illustrated for use, for example, with a box end wrench 910. This embodiment is provided to illustrate that the head cover according to the present invention may be used with wrenches other than ratchet wrenches. Here, head cover 920 includes a flat plate portion 922 from which a downwardly depending surrounding skirt 94 depends. Exposed surface 925 may be provided with indicia, as described above. Skirt 924 has an inwardly turned lip 926 so that it may be mounted over working head 930 of wrench 910 so as to encompass all of the lower surface thereof. To this end, a notch 932 is provided to accommodate handle 912.

FIG. 25 illustrates another embodiment in the form of a head cover 950 adapted to mount on wrench 960 that includes a handle 970. Here, wrench 960 is in the form of a deep socket 964 that is permanently affixed to handle 962. Head cover 970 includes a pair of side wings, such as side wing 972 which downwardly depend from flat plate portion 974. Likewise, a front wing portion 976 depends downwardly from flat plate portion 974. Suitable wing recesses are provided in a manner described above, so that such description is not again repeated. Again, intermating cooperative interlocking structures may be provided, all in the manner of that described with respect to the first embodiment. Head cover is again provided to show that a head cover may be used with other types of wrenches.

From the foregoing, it should also be appreciated that the present invention contemplates a method of providing a wrench with selected indicia. This method may include any steps inherent in the above-described structures. Broadly, the method provides selected indicia wherein the wrench has a forwardly located working head with a surrounding sidewall extending between an upper edge and a lower edge that is opposite the upper edge. Furthermore, the wrench includes a handle extending longitudinally and rearwardly of the working head along a longitudinal axis. According to the broad method, a head cap is provided that includes a generally flat plate portion having a peripheral edge portion and opposite first and second surfaces and that has selected indicia located on the first surface. The method then includes the step of securing the head cap to the working head to define a mounted state such that the second surface confronts the working head with the first surface forming an exposed surface on the working head. Here, the flat plate portion is sized and configured so that it spans a majority of the region surrounded by the upper edge of the working head with the peripheral edge portion of the head cap being substantially co-extensive with the upper edge of the working head when in the mounted state. The method may also include the step of securing the head cap by providing a mounting structure that downwardly depends from the peripheral edge portion and mechanically engaging the surrounding sidewall of the working head with this mounting structure. It is noted, the method may include other steps contemplated by the forgoing structures.

Accordingly, the present invention has been described with some degree of particularity directed to the exemplary embodiments of the present invention. It should be appreciated, though, that modifications or changes may be made to the exemplary embodiments of the present invention without departing from the inventive concepts contained herein.

Accordingly, the present invention has been described with some degree of particularity directed to the exemplary embodiments. It should be appreciated, though, that modifications or changes may be made to the exemplary embodiments without departing from the inventive concepts contained herein.

I claim:

1. In a wrench adapted to engage a work piece whereby a user may apply a rotational force thereto with mechanical advantage wherein said wrench includes a forwardly located working head having a lower tool piece and a surrounding sidewall extending between an upper edge and a lower edge opposite the upper edge thereof and including a handle extending longitudinally and rearwardly of said working head along a longitudinal axis, the improvement comprising a head cap secureable to said working head in a mounted state, said head cap having an exposed surface that forms an upper surface for said working head when in the mounted state.

2. The improvement according to claim 1 wherein said head cap includes a generally flat plate portion that spans a majority of the region surrounded by said upper edge.

3. The improvement according to claim 1 wherein said head cap has a peripheral edge that is substantially coextensive with said upper edge when in the mounted state.

4. The improvement according to claim 3 wherein said exposed surface is provided with indicia thereon.

5. The improvement according to claim 1 wherein said head cap includes a generally flat plate portion having a peripheral edge portion and at least one wing portion that downwardly depends from said peripheral edge and that is operative to engage said surrounding sidewall when in the mounted state.

6. The improvement according to claim 5 wherein said head cap includes a pair of side wing portions that downwardly depend from said peripheral edge portion in opposed relation to one another, each of said side wing portions operative to engage said surrounding sidewall when in the mounted state.

7. The improvement according to claim 6 including a downwardly depending front wing portion located forwardly of said side wing portions, said front wing portion operative to engage said surrounding sidewall when in the mounted state.

8. The improvement according to claim 6 wherein said side wing portions are oriented at a small acute angle relative to a longitudinal plane that is perpendicular to said flat plate portion.

9. The improvement according to claim 5 wherein said wing portion and said sidewall include cooperative interlock structures operative to engage one another so as to secure said head cap to said working head when said head cap is in the mounted state.

10. The improvement according to claim 9 wherein one of said interlock structures is a cavity and another of said interlock structures is a protrusion sized to mate with the cavity.

11. The improvement according to claim 5 wherein said surrounding sidewall has a wing recess formed therein that is sized and adapted to mate with said wing portion.

12. The improvement according to claim 11 wherein said wing portion includes an inwardly projecting protrusion and wherein said wing recess has a cavity formed therein that is sized and oriented to mateably engage said protrusion when in the mounted state.

13. The improvement according to claim 12 wherein said wing portion has a notch formed therein that is operative to assist in releasing said head cap from the mounted state.

14. The improvement according to claim 1 wherein said head cap is constructed of a stiff, resilient material.

15. The improvement according to claim 1 wherein the exposed surface has a cover recess formed therein and including an insert piece sized and adapted to nest therein.

16. The improvement according to claim 1 wherein said head cap includes a mounting element disposed on the upper surface thereof, said mounting element being configured to releasably attach a selected accessory thereto.

17. The improvement according to claim 1 wherein said wrench is a ratchet wrench that includes a drive mechanism having drive and ratchet control elements located in said working head, said head cap operative to retain at least one of said drive and ratchet control elements in said working head.

18. In a ratchet wrench including a forwardly located working head and a handle extending longitudinally and rearwardly thereof for applying a rotational force to said working head with mechanical advantage, said working head including a surrounding sidewall extending between an upper edge and a lower edge opposite the upper edge to form a head cavity, a drive mechanism disposed the head cavity and having drive and ratchet control elements for selectively and reversibly rotating a lower drive stud that projects from a lower surface of said working head, the improvement comprising a head cap secureable to said working head in a mounted state on a side thereof opposite the lower surface, said head cap constructed of a stiff, resilient material and including a generally flat plate portion having a peripheral edge portion that is substantially coextensive with said upper edge when in the mounted state so as to have an exposed surface that forms an upper surface for said working head when in the mounted state.

19. The improvement according to claim 18 wherein said head cap includes a pair of side wing portions that downwardly depend from said peripheral edge portion in opposed relation to one another, each of said side wing portions operative to engage said surrounding sidewall when in the mounted state.

20. The improvement according to claim 19 including a downwardly depending front wing portion located forwardly of said side wing portions, said front wing portion operative to engage said surrounding sidewall when in the mounted state.

21. The improvement according to claim 19 wherein said side wing portions and said sidewall include cooperative interlock structures operative to engage one another so as to secure said head cap to said working head when said head cap is in the mounted state.

22. The improvement according to claim 21 wherein one of said interlock structures is a cavity and another of said interlock structures is a protrusion sized to mate with the cavity.

23. The improvement according to claim 19 wherein said surrounding sidewall has a pair of wing recesses formed therein that are sized and located to mate with said side wing portions.

24. The improvement according to claim 18 wherein said working head includes a top wall that is joined to said surrounding sidewall proximately to said upper edge so as to provide a recess with a rim that at least partially surrounds said top wall, said head cap having a peripheral shoulder so as to define a central portion that seats in the recess.

25. The improvement according to claim 18 wherein said head cap operative to secure and retain at least one of said drive and ratchet control elements in said working head.

26. A head cap adapted to secure to the working head of a wrench, comprising:
(A) a generally flat plate portion having a peripheral edge portion; and
(B) first and second wing portions that extend from said peripheral edge portion in generally parallel, opposed relation to one another and are oriented so as to engage the working head of the wrench when in a mounted state such that said flat plate portion has an exposed surface that forms an upper surface for said working head when in the mounted state.

27. A head cap according to claim 26 including a third wing portion located in spaced relation to each of said first and second wing portions, said third wing portion operative to engage the working head when in the mounted state.

28. A head cap according to claim 26 wherein each of said first and second wing portions are oriented at a small acute angle relative to a plane that is perpendicular to said flat plate portion.

29. A head cap according to claim 26 wherein each of said first and second wing portions include a ramp-like protrusion adapted to engage said working head when in the mounted state.

30. A head cap according to claim 26 wherein at least one of said first and second wing portions has a notch formed therein that is operative to assist in releasing said head cap from the mounted state.

31. A head cap according to claim 26 wherein said head cap is constructed of a stiff, resilient material.

32. A head cap according to claim 26 wherein said exposed surface is provided with indicia thereon.

33. A head cap according to claim 26 wherein said peripheral edge portion has a peripheral shoulder formed therein.

34. A method of providing a wrench with selected indicia wherein said wrench includes a forwardly located working head having a surrounding sidewall extending between an upper edge and a lower edge opposite the upper edge thereof and including a handle extending longitudinally and rearwardly of said working head along a longitudinal axis, comprising:
(A) providing a head cap that includes a generally flat plate portion having a peripheral edge portion and opposite first and second surfaces and that has the selected indicia located on the first surface; and
(B) securing said head cap to said working head to define a mounted state such that the second surface confronts said working head with the first surface forming an exposed surface on said working head, said flat plate portion being sized and configured so that it spans a majority of the region surrounded by said upper edge with said peripheral edge portion being substantially coextensive with said upper edge of the working head when in the mounted state.

35. The method according to claim 34 wherein the step of securing said head cap is accomplished by providing a mounting structure that downwardly depends from said peripheral edge portion and mechanically engaging the surrounding sidewall of said working head with said mounting structure.
